(19) United States
(12) Patent Application Publication
(10) Pub. No.: US 2025/0094976 A1
(43) Pub. Date: Mar. 20, 2025

(54) SYSTEM AND METHODS FOR GENERATING A TEMPORARY, LIMITED USE MACHINE-READABLE CODE ASSOCIATED WITH AN ACCOUNT

(71) Applicant: Mastercard International Incorporated, Purchase, NY (US)

(72) Inventors: Premshan Paul, Pune (IN); Chris Mavromatis, Crestwood, MO (US); Parthasarathy Munuswamy Krishnamoorthy, Lake Saint Louis, MO (US); Jennifer Hausman-Wilcox, Dardeen Prairie, MO (US); Trevor Scott Owen, Saint Peters, MO (US)

(73) Assignee: Mastercard International Incorporated, Purchase, NY (US)

(21) Appl. No.: 18/469,941

(22) Filed: Sep. 19, 2023

(51) Int. Cl. G06Q 20/40

(52) U.S. Cl. CPC G06Q 20/40

(57) ABSTRACT

A financial account proxy system receives a data packet from a first cardholder device. The data packet includes a limited use machine-readable code, receiver information corresponding to a second cardholder device, and one or more limitations. The machine-readable code, receiver information, and limitations are stored. The machine-readable code is associated with a primary account number of a financial account of the primary cardholder. A pre-authorization request message is transmitted to an issuer of the financial account, and pre-authorization details are received from the issuer. The limited use machine-readable code is transmitted to the second cardholder device. A transaction request authorization message is received from a POS terminal. The transaction request authorization message is associated with a transaction performed with the machine-readable code. The transaction request authorization message includes transaction details and the machine-readable code. A determination is made as to whether the transaction details violate one of the limitations.

### FIELD OF THE DISCLOSURE

The field of the disclosure relates generally to an account proxy or surrogate and, more particularly, to systems and methods for establishing and sharing a machine-readable code associated with an account and establishing limitations on the use of the machine-readable code.

### BACKGROUND OF THE DISCLOSURE

Consumers may choose to provide temporary access to their transaction card to a family member, friend, or another individual who is not associated with the consumer's account. However, typically, a consumer must present a physical transaction card to a merchant to be processed by a point-of-sale device when performing a transaction. In such instances, the consumer may be required to provide a personal identification number or a signature for the transaction to be processed. If the consumer wishes for another authorized user to make a purchase with the transaction card, the physical card must be transferred to the authorized user (or the authorized user must have a second physical card that is associated with the account). However, when the two consumers are in separate locations, such a transfer is not immediately possible.

Alternatively, consumers may have their transaction card details stored in a digital wallet on their personal mobile device. The digital wallet provides consumers with a secure and convenient way to pay for purchases. Upon registration, consumers may store their transaction card in the digital wallet and may access that information to pay conveniently and securely across participating merchants. However, it is not currently possible to transfer the digital wallet transaction card details to another consumer for temporary use.

### BRIEF DESCRIPTION OF THE DISCLOSURE

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a financial account proxy system is provided. The system includes a processor and a memory device. Computer-executable instructions are stored on the memory device. When executed by the processor, the computer-executable instructions cause the processor to receive, via an application programming interface (API) call, a data packet from a first cardholder device associated with a primary cardholder. The data packet includes a limited use machine-readable code, receiver information corresponding to a second cardholder device associated with a secondary cardholder, and one or more limitations. The processor stores the limited use machine-readable code, receiver information, and one or more limitations in the memory device. The limited use machine-readable code is stored in association with a primary account number (PAN) of a financial account of the primary cardholder. The processor also transmits a pre-authorization request message to an issuer of the financial account of the primary cardholder, and receives pre-authorization details from the issuer. The processor then stores the pre-authorization details in the memory device. In addition, the processor transmits the limited use machine-readable code to the second cardholder device based on the receiver information. Furthermore, the processor receives a transaction request authorization message from a merchant point-of-sale (POS) terminal. The transaction request authorization message is associated with a transaction performed with the limited use machine-readable code. The transaction request authorization message includes transaction details and the limited use machine-readable code. The processor then determines whether the transaction details violate one of the one or more limitations.

In another aspect, a computer-implemented method is provided. The method includes receiving, via an application programming interface (API) call, a data packet from a first cardholder device associated with a primary cardholder. The data packet includes a limited use machine-readable code, receiver information corresponding to a second cardholder device associated with a secondary cardholder, and one or more limitations. The method also includes storing, in the memory device, the limited use machine-readable code, receiver information, and one or more limitations. The limited use machine-readable code is stored in association with a primary account number (PAN) of a financial account of the primary cardholder. Furthermore, the method includes transmitting a pre-authorization request message to an issuer of the financial account of the primary cardholder, and receiving pre-authorization details from the issuer. The method includes storing the pre-authorization details in the memory device. Moreover, the method includes transmitting the limited use machine-readable code to the second cardholder device based on the receiver information. The method also includes receiving a transaction request authorization message from a merchant point-of-sale (POS) terminal. The transaction request authorization message is associated with a transaction performed with the limited use machine-readable code. The transaction request authorization message includes transaction details and the limited use machine-readable code. Additionally, the method includes determining whether the transaction details violate one of the one or more limitations.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an example multi-party transaction card network system that includes a financial account proxy system, in accordance with an aspect of the present invention;

FIG. 2 is a simplified block diagram of an example payment network, including the financial account proxy system of FIG. 1;

FIG. 3 is an example configuration of a user system operated by a user, such as a cardholder shown in FIG. 1;

FIG. 4 is an example configuration of a server system, such as a server system shown in FIG. 2;

FIG. 5 is a schematic diagram showing operation of the financial account proxy system of FIG. 1;

FIG. 6 is a flowchart illustrating an exemplary computer-implemented method for registering one or more registrants for the financial account proxy service provided by the financial account proxy system of FIG. 1, in accordance with one embodiment of the present disclosure; and

FIG. 7 is a flow chart of an example method for creating and sharing a limited use machine-readable code associated with a primary cardholder's financial account (or PAN) with a secondary cardholder, in accordance with one embodiment of the present disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

As used herein, the term “database” includes either a body of data, a relational database management system (RDBMS), or both. As used herein, a database includes, for example, and without limitation, a collection of data including hierarchical databases, relational databases, flat file databases, object-relational databases, object-oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL. However, any database may be used that enables the systems and methods to operate as described herein.

### Example of Transaction Card Transaction Network

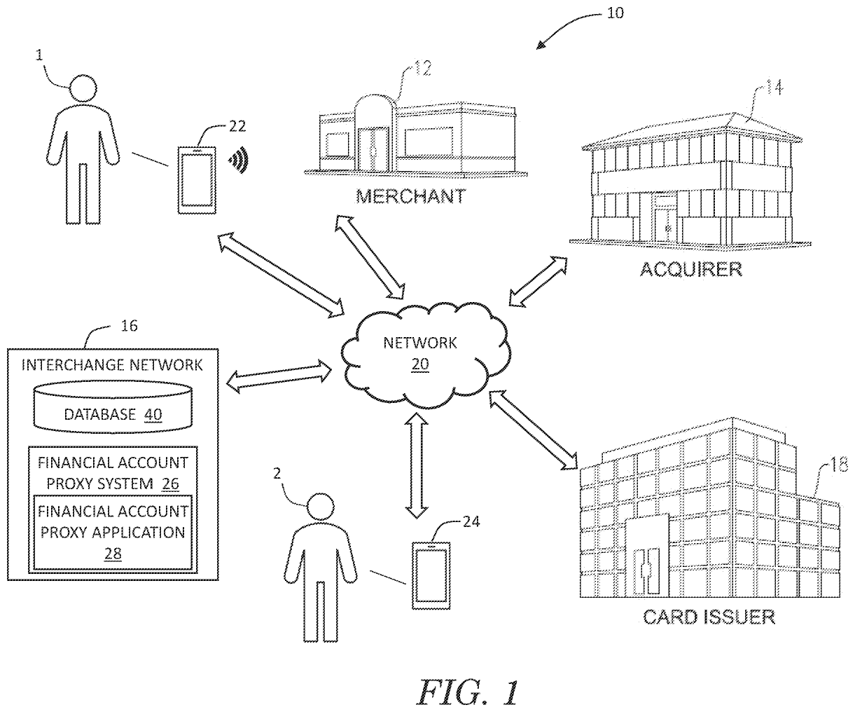

FIG. 1 is a block diagram of an example multi-party transaction card network system 10 that includes a financial account proxy system 26. The transaction card network system 10 facilitates providing interchange network services offered by an interchange network 16. In addition, the transaction card network system 10 enables transaction card transactions in which merchants 12, acquirers 14, and/or card issuers 18 do not need to have a one-to-one relationship. Although parts of the transaction card network system 10 are presented in one arrangement, other embodiments may include the same or different parts arranged otherwise, depending, for example, on authorization processes for purchase transactions, communication between computing devices, etc.

In the example embodiment, the transaction card network system 10 generally includes the merchants 12, the acquirers 14, the interchange network 16, and the issuers 18, coupled in communication via a network 20. The network 20 includes, for example and without limitation, one or more of a local area network (LAN), a wide area network (WAN) (e.g., the Internet, etc.), a mobile network, a virtual network, and/or any other suitable public and/or private network capable of facilitating communication among the merchants 12, the acquirers 14, the interchange network 16, and/or the issuers 18. In some embodiments, the network 20 may include more than one type of network, such as a private payment transaction network provided by the interchange network 16 to the acquirers 14 and the issuers 18 and, separately, the public Internet, which may facilitate communication between the merchants 12, the interchange network 16, the acquirers 14, and consumers, etc.

Embodiments described herein may relate to a transaction card system, such as a credit card payment system using the Mastercard® interchange network. (Mastercard is a registered trademark of Mastercard International Incorporated). The Mastercard interchange network is a set of proprietary communications standards promulgated by Mastercard International Incorporated for the exchange of financial transaction data and the settlement of funds between financial institutions that are members of Mastercard International Incorporated.

In the example embodiment, the transaction card network system 10 also includes a first cardholder device 22 and a second cardholder device 24. The first cardholder device 22 may be associated with a first consumer or cardholder 1. The second cardholder device 24 may be associated with a second consumer or cardholder 2.

In a typical transaction card system, a financial institution called the “issuer” issues a financial account and associated transaction card, such as a credit card, to a cardholder, such as the cardholder 1. The cardholder 1 uses the transaction card to tender payment for a purchase from the merchant 12. In the example embodiment, the merchant 12 is typically associated with products, such as goods and/or services, that are offered for sale and are sold to the cardholder 1. The merchant 12 includes, for example, a physical location and/or a virtual location. A physical location includes, for example, a brick-and-mortar store, etc., and a virtual location includes, for example, an Internet-based store-front. In the example embodiment, the cardholder 1 may provide a limited use machine-readable code (such as a barcode, quick response (QR) code, or the like) to the cardholder 2 (e.g., to the second cardholder device 24), via the financial account proxy system 26. The limited use machine-readable code is associated with the financial account and associated transaction card of cardholder 1. Thus, the cardholder 2 may use the limited use machine-readable code to tender payment for a purchase from the merchant 12, wherein the purchase amount is charged to the first cardholder's 1 financial account.

To accept payment with the transaction card and/or the limited use machine-readable code, the merchant 12 must normally establish an account with a financial institution that is part of the transaction card network system 10. This financial institution is usually called the “merchant bank,” the “acquiring bank,” or the acquirer 14. When the cardholders 1 or 2 present payment for a purchase with, for example, a transaction card, a digital wallet, the limited use machine-readable code, and the like, the merchant 12 requests authorization from the acquirer 14 for the amount of the purchase. The request may be performed over the telephone but is usually performed through the use of a point-of-sale terminal that reads the cardholder's account information from a magnetic stripe, a chip, or embossed characters on the transaction card and/or wirelessly via the digital wallet and communicates electronically with the transaction processing computers of the acquirer 14. Alternatively, the acquirer 14 may authorize a third party to perform transaction processing on its behalf. In this case, the point-of-sale terminal will be configured to communicate with the third party. Such a third party is usually called a “merchant processor,” an “acquiring processor,” or a “third party processor.”

Using the interchange network 16, computers of the acquirer 14 or merchant processor will communicate with computers of the issuer 18 to determine whether the cardholder's account is in good standing and whether the purchase is covered by the cardholder's available credit line. Based on these determinations, the request for authorization will be declined or accepted. If the request is accepted, an authorization code is issued to the merchant 12.

When a request for authorization is accepted, the available credit line of the cardholder's account is decreased. Normally, a charge for a transaction card transaction is not posted immediately to the cardholder's account because bankcard associations, such as Mastercard International Incorporated, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on the point-of-sale terminal. This may include bundling of approved transactions daily for standard retail purchases. If the cardholder 1 or 2 cancels the transaction before it is captured, a “void” is generated. If the cardholder 1 or 2 returns goods after the transaction has been captured, a “credit” is generated. The interchange network 16 and/or the issuer 18 stores the transaction card information, such as, and without limitation, a type of merchant, a merchant identifier, a location where the transaction was completed, an amount of purchase, and a date and time of the transaction, in a database 40.

After a purchase has been made, a clearing process occurs to transfer additional transaction data related to the purchase among the parties to the transaction, such as the acquirer 14, the interchange network 16, and the issuer 18. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among the merchant 12, the acquirer 14, and the issuer 18. Settlement refers to the transfer of financial data or funds among the merchant 12, the acquirer 14, and the issuer 18 related to the transaction. Usually, transactions are captured and accumulated into a “batch,” which is settled as a group. More specifically, a transaction is typically settled between the issuer 18 and the interchange network 16, and then between the interchange network 16 and the acquirer 14, and then between the acquirer 14 and the merchant 12.

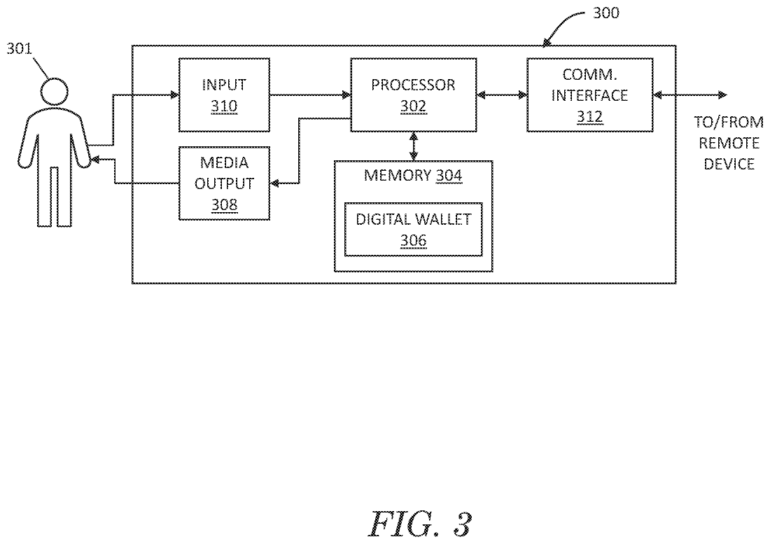

In some embodiments, the transaction is a card-not-present (CNP) transaction. The CNP transaction may be conducted, for example, with a transaction card, a limited use machine-readable code, and/or a virtual payment account number (virtual PAN) stored as digital wallet data in a digital wallet 306 (shown in FIG. 3). The interchange network 16 includes the financial account proxy system 26 that is configured to analyze various data associated with the transaction card transaction and provide various information to one or more parties involved in the transaction card transaction, such as the merchant 12 and the acquirer 14. The financial account proxy system 26 is a specially programmed computer system that enables the interchange network 16 to receive, store, and/or transmit a.) data related to a primary account number (PAN) or limited use machine-readable code (e.g., having a shared virtual PAN encoded therein); b.) notifications associated with the PAN and/or limited use machine-readable code; and/or c.) user selected limitations associated with the limited use machine-readable code. The financial account proxy system 26 includes a financial account proxy application 28. The financial account proxy application 28 facilitates communication between the financial account proxy system 26 and one or more authorized users or cardholders, such as cardholders 1 and 2, of the limited use machine-readable code via the cardholder's digital wallet 306.

### Exemplary Computer Systems

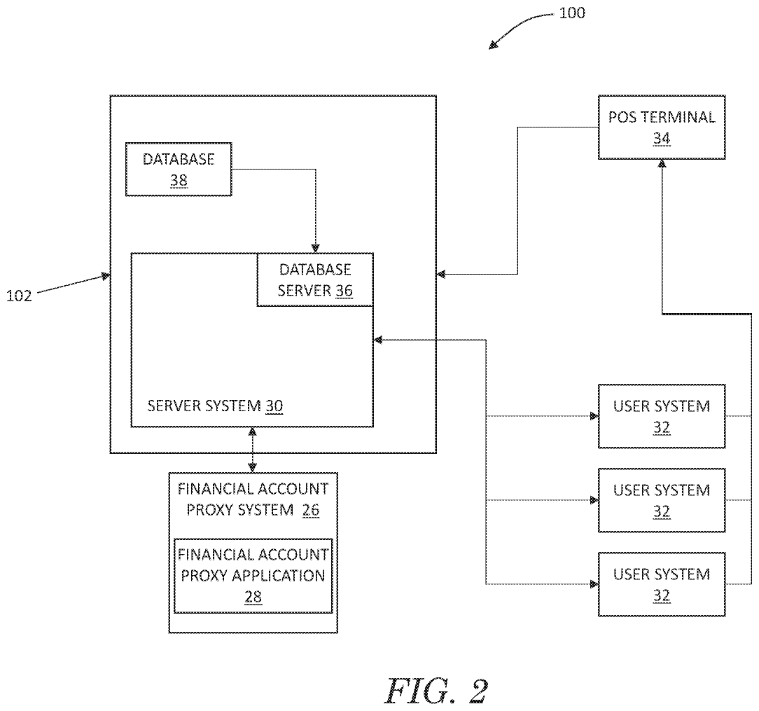

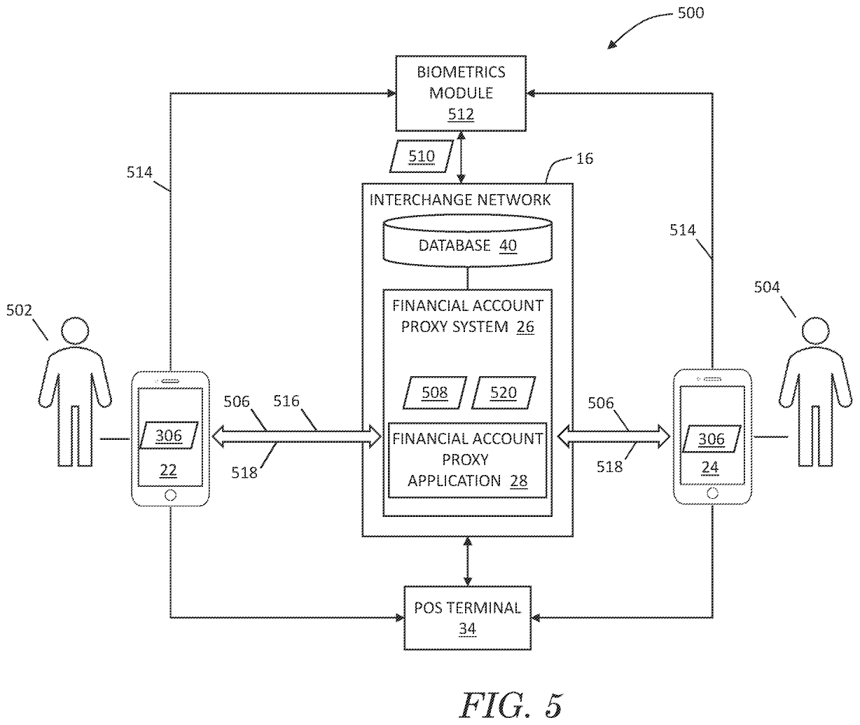

FIG. 2 is a simplified block diagram of an example payment network 100 having transaction processing system 102 for providing access to users, such as the cardholders 1 and 2 (shown in FIG. 1), to the PAN and/or the limited use machine-readable code (shown in FIG. 5 as item 520) using the financial account proxy system 26.

In one embodiment, the limited use machine-readable code 520 is a quick response (QR) code. A QR code is a two-dimensional barcode or matrix barcode that is defined by the international standard ISO/IEC 18004:2015. A QR code includes three distinctive marks at different corners of the QR code image and one or more smaller marks proximate a fourth corner to normalize the image for size, orientation, and angle of viewing. In addition, dispersed within the four corners of the QR code are a plurality of small dots that can be converted to binary numbers and validated with an error-correcting algorithm. The binary number includes data that is encoded within the QR code. In one suitable embodiment, the data encoded in the QR code includes a virtual PAN, a PAN, or other token associated with a financial account, transaction data, and the like.

While the machine-readable code 520 described herein is in reference to a QR code, the disclosure contemplates that any type of machine-readable code may be used that enables the network system 100 to function as described herein. For example, the machine-readable code 520 may include one or more of one dimensional barcode formats, such as a UPC, code 39, EAN 8, or EAN 13, other two-dimensional formats such as PDF417 or Datamatrix, other n-dimensional barcode formats, and/or alphanumeric text or symbols or the like.

In some embodiments, the payment network 100 is similar to the transaction card network system 10 (shown in FIG. 1). In the example embodiment, the payment network 100 includes a plurality of computing devices connected in accordance with the present disclosure. The payment network 100 includes a server system 30 of the processing system 102 in communication with a point-of-sale (POS) terminal 34. The POS terminal 34 may be located, for example, at a merchant location 12 (shown in FIG. 1). The server system 30 is also in communication with a plurality of user systems 32 associated with the cardholders (i.e., consumers).

In an embodiment, the user systems 32 are mobile computing devices, such as the first and second cardholder devices 22 and 24 (shown in FIG. 1), including digital wallets. It is contemplated, however, that the user systems 32 can be any devices, such as mobile phones, Smartphones, personal digital assistants (PDAs), key fobs, and/or computers, such that server system 30 is accessible to the user systems 32 using the Internet. The user systems 32 are interconnected to the Internet through one or more of many interface types including, for example, a network, such as a wireless network adapter or a wireless data transceiver for use with Bluetooth communication, radio frequency communication, near field communication (NFC), and/or with a mobile phone network, Global System for Mobile communications (GSM), 3G, 4G, 5G, or other mobile data network, and/or Worldwide Interoperability for Microwave Access (WiMax) and the like. The user systems 32 may be any device capable of interconnecting to the Internet including an Internet connected phone, a PDA, or any other suitable web-based connectable equipment.

In the example embodiment, the processing system 102 includes one or more POS terminals 34, which may be connected to the user systems 32 and the server system 30. The POS terminal(s) 34 may be interconnected to the Internet (or any other network that allows the POS terminal(s) 34 to communicate as described herein) through many interfaces including a network, such as a local area network (LAN) or a wide area network (WAN), dial-in-connections, cable modems, wireless modems, and special high-speed ISDN lines. The POS terminal(s) 34 are any device capable of interconnecting to the Internet and including an input device capable of reading information from a cardholder's financial transaction card and/or limited use machine-readable code 520. In some embodiments, the POS terminal 34 may be a cardholder's personal computing device, such as when conducting an online purchase through the Internet. As used herein, the terms POS device, POS terminal, and point-of-interaction device are used broadly, generally, and interchangeably to refer to any device in which a cardholder interacts with a merchant to complete a financial transaction.

A database server 36 is connected to a database 38, which is configured to store information on a variety of matters. In one embodiment, the database 38 is a centralized database stored on the server system 30 and can be accessed by potential users at one of the user systems 32 by logging onto the server system 30 through one of the user systems 32. In an alternative embodiment, the database 38 is stored remotely from the server system 30 and may be a distributed or non-centralized database.

In one example embodiment, the database 38 may include a single database having separated sections or partitions or may include multiple databases, each being separate from each other. The database 38 may store transaction data generated as part of sales activities and savings activities conducted over the processing network including data relating to merchants, account holders or customers, issuers, acquirers, savings amounts, savings account information, and/or purchases made. The database 38 may also store account data including at least one of a cardholder name, a cardholder address, an account number, and other account identifier. The database 38 may also store merchant data including a merchant identifier that identifies each merchant registered to use the network, and instructions for settling transactions including merchant bank account information. The database 38 may also store purchase data associated with items purchased by a cardholder from a merchant, and authorization request data. The database 38 may also store digital wallet data 306, device information, a PAN, virtual PAN, and/or limited use machine-readable codes, and other data involved with providing access to a primary account number to one or more parties to the transaction.

In the example embodiment, one of the user systems 32 may be associated with the cardholder 1 or 2 (shown in FIG. 1), while the POS terminal 34 may be associated with the merchant 12 (shown in FIG. 1) or may be a computer system and/or mobile system used by the cardholders 1 or 2 while making an on-line purchase or payment. The server system 30 may be associated with the interchange network 16 or a payment processor. In the example embodiment, the server system 30 is associated with a financial transaction processing network, such as the interchange network 16, and may be referred to as an interchange computer system. The server system 30 may be used for processing transaction data. In addition, the user systems 32 and the POS terminal 34 may include a computer system associated with at least one of a merchant, an online bank, a bill payment outsourcer, an acquirer bank, an acquirer processor, an issuer bank associated with a transaction card, an issuer processor, a remote payment processing system, and/or a biller.

In the example embodiment, the processing system 102 is in communication with the financial account proxy system 26 and the financial account proxy application 28, which may be associated with the interchange network 16 or with an outside third party in a contractual relationship with the interchange network 16. In the example embodiment, the financial account proxy system 26 receives requests from a primary cardholder, such as the cardholder 1, to share the cardholder's financial account (e.g., the PAN) with a secondary cardholder, such as the cardholder 2, via a limited use machine-readable code 520 (e.g., a virtual PAN). In addition, the financial account proxy system 26 receives requests from the primary cardholder 1 to add a secondary cardholder 2, and receives limitations to be placed on the limited use machine-readable code 520. The primary cardholders are generally cardholders 1 that hold the primary financial account (i.e., the PAN), set the limits on the limited use machine-readable code 520, and are ultimately responsible for the debt accrued using the limited use machine-readable code 520. In contrast, the secondary cardholders are generally cardholders 2 that the primary cardholder 1 wants to have some control over regarding the secondary cardholder's 2 use of the limited use machine-readable code 520.

In some embodiments, the financial account proxy system 26 and/or the financial account proxy application 28 are also in communication with a merchant system and/or an issuer system (not shown) and/or the POS terminal 34 of the merchant 12. It is noted that the payment network 100 may include more, fewer, or alternative components and/or perform more, fewer, or alternative actions, including those discussed elsewhere herein.

FIG. 3 is an example configuration of a user system 300 operated by a user 301, such as the cardholders 1 and/or 2 (shown in FIG. 1). In some embodiments, the user system 300 is a client system 32 and/or a merchant POS terminal 34 (shown in FIG. 2).

In the example embodiment, the user system 300 includes a processor 302 for executing instructions. In some embodiments, executable instructions are stored in a memory device 304. The processor 302 includes one or more processing units, for example, a multi-core configuration. The memory device 304 is any device allowing information such as the digital wallet data 306, executable instructions, and the like to be stored and retrieved. The memory device 304 includes one or more computer readable media.

The user system 300 also includes at least one media output component 308 for presenting information to the user 301. The media output component 308 is any component capable of conveying information to the user 301. In some embodiments, the media output component 308 includes an output adapter such as a video adapter and/or an audio adapter. An output adapter is operatively coupled to the processor 302 and operatively connectable to an output device such as a display device, such as a liquid crystal display (LCD), organic light emitting diode (OLED) display, or “electronic ink” display, or an audio output device, such as a speaker or headphones.

In some embodiments, the user system 300 includes an input device 310 for receiving input from the user 301. The input device 310 may include, for example, a touch sensitive panel, a touch pad, a touch screen, a stylus, a gyroscope, an accelerometer, a position detector, a keyboard, a pointing device, a mouse, or an audio input device. A single component such as a touch screen may function as both an output device of the media output component 308 and the input device 310. The user system 300 may also include a communication interface 312, which is communicatively connectable to a remote device such as the server system 30 and/or the POS terminal 34 (shown in FIG. 2). The communication interface 312 may include, for example, a wired or wireless network adapter or a wireless data transceiver for use with Bluetooth communication, radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 304 are, for example, computer readable instructions for providing a user interface to the user 301 via the media output component 308 and, optionally, receiving and processing input from the input device 310. A user interface may include, among other possibilities, a web browser and various software applications, such as a digital wallet application. Web browsers enable users, such as the user 301, to display and interact with media and other information typically embedded on a web page or a website from the server system 30. The various software applications allow the user 301 to interact with a server application, such as the financial account proxy application 28, from the server system 30 to facilitate receiving/providing various services.

In the example embodiment, the user system 300 is a user computing device from which the user 301 engages with a digital wallet 306, an online merchant (e.g., the merchant 12 shown in FIG. 1), an interchange network (e.g., the interchange network 16 shown in FIG. 1), and an issuer of a transaction card (e.g., the issuer 18 shown in FIG. 1) to perform a financial transaction using, for example, the a cardholder's financial account and/or the limited use machine-readable code 520.

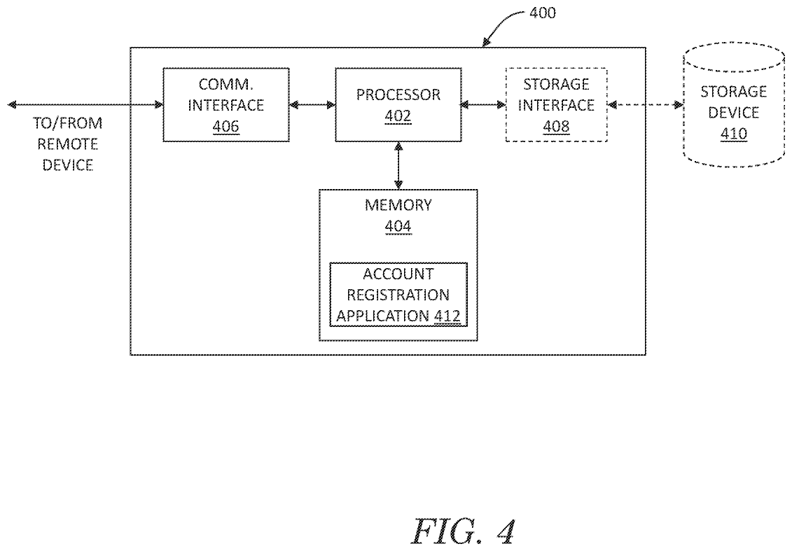

FIG. 4 is an example configuration of a server system 400, such as the server system 30 (shown in FIG. 2). The server system 400 includes, but is not limited to, the financial account proxy system 26 (shown in FIG. 1). In the example embodiment, the server system 400 includes a processor 402 for executing instructions. The instructions may be stored in a memory 404, for example. The processor 402 includes one or more processing units (e.g., in a multi-core configuration) for executing the instructions. The instructions may be executed within a variety of different operating systems on the server system 400, such as UNIX, LINUX, Microsoft Windows®, etc. More specifically, the instructions may cause various data manipulations on data stored in a storage device 410 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C #, C++, Java, or other suitable programming languages, etc.).

The processor 402 is operatively coupled to a communication interface 406 such that the server system 400 can communicate with a remote device such as a user system 300 (shown in FIG. 3) or another server system 400. For example, the communication interface 406 may receive communications from a client system 32 via the Internet, as illustrated in FIG. 2.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is similar to the database 40. For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In an embodiment, the memory 404 includes an account registration application 412 stored thereon that, when executed by the processor 402, enables the server system 400 to handle registration requests from cardholders, such as the cardholders 1 and/or 2 (shown in FIG. 1), to register for financial account proxy services provided by the server system 400 (e.g., the financial account proxy system 26). Using the account registration application 412, the cardholders 1 and/or 2 and/or other entities create an account. The account operates to allow the cardholders 1 and/or 2 and/or other entities to provide account data to and/or receive financial account proxy services from the server system 400.

In the example embodiment, server system 400 is the financial account proxy system 26, coupled in communication with one or more of the user system 32 (shown in FIG. 2), the interchange network 16, and/or the merchant 12 during a financial transaction involving, for example, the limited use machine-readable code 520, which may be stored in the digital wallet 306 (shown in FIG. 3) of a user, such as the cardholder 2 (shown in FIG. 1). The server system 400 checks for financial accounts, associated limited use machine-readable codes 520, and account information updates and/or limitations for limited use machine-readable codes 520 performing a financial transaction.

FIG. 5 is a schematic diagram showing operation of the financial account proxy system 26. As described herein, the financial account proxy system 26 is configured to receive requests from a primary cardholder 502 (e.g., cardholder 1 (shown in FIG. 1)) to share the cardholder's financial account (or PAN) with a secondary cardholder 504 (e.g., cardholder 2 (shown in FIG. 1)) via the limited use machine-readable code 520. In addition, the financial account proxy system 26 receives requests from the primary cardholder 502 to add a secondary cardholder, such as secondary cardholder 504, and receives limitations to be placed on the limited use machine-readable code 520. In some embodiments, the financial account proxy system 26 and/or the financial account proxy application 28 are also in communication with a merchant system and/or an issuer system (not shown) and/or the POS terminal 34 of the merchant 12. In the example embodiment, the financial account proxy system 26 is a component of a payment network, such as transaction card interchange network 16.

In the example embodiment, the financial account proxy system 26 is programmed to communicate with one or more client systems, such as the first cardholder device 22 and the second cardholder device 24, via the account registration application 412 (shown in FIG. 4) to receive user identification data 506 to facilitate activating a user, such as the primary cardholder 502 and/or the secondary cardholder 504, that is not registered with the financial account proxy system 26. In particular, the user activation process creates a user account and associated credentials for use with the financial account proxy system 26 and/or the financial account proxy application 28. The user, such as the primary cardholder 502 and/or the secondary cardholder 504, enters the user identification data 506 for transmission to the financial account proxy system 26. The user identification data 506 may include, for example, and without limitation, identification data relating to the identity of the user, such as the primary cardholder 502 and/or the secondary cardholder 504. Specifically, the identification data 506 may include identifying information of the user, such as the user's name, email address, password, cellular phone number, etc. Furthermore, the identification data 506 may include hardware identification data (e.g., an Electronic Serial Number (ESN), Mobile Equipment Identifier (MEID), International Mobile Equipment Identity (IMEI) number, and the like) of the first cardholder device 22 and/or the second cardholder device 24. The user identification data 506 is stored in the database 40. The financial account proxy system 26 generates a user account 508 from the user identification data 506 for each respective user.

The financial account proxy system 26 also receives a biometric profile 510 from a biometrics module 512. The biometric profile 510 may include, for example, biometrics of a respective user, such as the primary cardholder 502 and/or the secondary cardholder 504. The biometrics of a respective user include, for example, one or more biometric scans or digital representations 514 of a physical feature(s) of the user that is to be validated during account setup and/or generation and use of the limited use machine-readable code 520. The physical feature(s) may include, for example, a fingerprint image, a voice recording, a retinal image, facial recognition, palm print image, iris recognition, and the like. Feature data from the biometric scan or digital representation may be extracted to select one or more features of interest. The respective biometric profile 510 may be stored, for example, in the database 40. The financial account proxy system 26 supplements each respective user account 508 with its respective biometric profile 510. The biometrics module 512 receives the one or more biometric scans or digital representations 514 of the physical feature(s) from the first cardholder device 22 and the second cardholder device 24, and uses them to generate the respective biometric profiles 510 and/or validate the one or more biometric scans or digital representations 514 against already stored biometric profiles 510.

In some embodiments, the financial account proxy system 26 facilitates communication between the financial account proxy application 28 and the digital wallet 306 (shown in FIG. 3) to send, receive, and store information related to the limited use machine-readable code 520, limitations 516 set for the secondary cardholder 504 associated with the limited use machine-readable code 520, notifications 518 of transactions made with the limited use machine-readable code 520, etc.

The primary cardholder 502 creates the limited use machine-readable code 520 and associates his or her financial account (or PAN) with the limited use machine-readable code 520. The primary cardholder 502 also creates one or more limitations 516 for the limited use machine-readable code 520. The one or more limitations 516 are stored in the financial account proxy system 26 (e.g., in the database 40). After establishing the limited use machine-readable code 520, the primary cardholder 502 invites the secondary cardholder 504 to download and/or otherwise link to the limited use machine-readable code 520. For example, in an embodiment, the primary cardholder 502 chooses a secondary cardholder 504 that has a user account 508 created with the financial account proxy system 26, using for example, the financial account proxy application 28. The secondary cardholder 504 receives a notification 518 that a limited use machine-readable code 520 is available for their use. Alternatively, in certain embodiments, the primary cardholder 502 sends a message, such as an SMS message, to the secondary cardholder 504. The message may include a notice or alert that a limited use machine-readable code 520 is available for use.

In some embodiments, if the secondary cardholder 504 has not registered an account with the financial account proxy system 26, the secondary cardholder establishes a user account 508 and accesses the limited use machine-readable code 520. In such an embodiment, the message (e.g., an SMS message) includes a link or other identifier that identifies the limited use machine-readable code 520 available for the secondary cardholder's 504 use.

The financial account proxy system 26 receives and stores the limitations 516 created by the primary cardholder 502. The limitations 516 may be established by the primary cardholder 502, for example, by specifying restrictions or approvals for the use of the limited use machine-readable code 520 by the secondary cardholder 504. In the exemplary embodiment, the limitations 516 may include, for example, one or more of a time restriction or limit, a spending amount, a transaction number limit, a geolocation or geofence, a Merchant Category Code(s) (MCCs), a merchant name(s), and/or other merchant identifiers.

During use of the limited use machine-readable code 520, the transaction data is transmitted to and validated by the financial account proxy system 26. The financial account proxy system 26 either authorizes or declines the transaction based on a comparison of the transaction data and the limitations that the primary cardholder 502 established for use of the limited use machine-readable code 520. For example, if the transaction data is within the requirements of the limitation 516, the transaction may be authorized. However, if the transaction data indicates that one or more of the limitations 516 is not met, the transaction is declined.

In an embodiment, the MCCs, merchant names, and/or other merchant identifiers may be assigned to selected types of merchants (e.g., department stores, grocery stores, wholesale clubs, bakeries, and the like) or may be assigned to specific stores within the selected types of merchants. Thus, when the secondary cardholder 504 uses limited use machine-readable code 520 as a payment device at a merchant 12, the POS device 34 of the merchant 12 sends an MCC identifier and/or another merchant identifier (e.g., a merchant ID) to the financial account proxy system 26, via the interchange network 16, in a transaction authorization request message. The financial account proxy system 26 extracts the MCC from the transaction authorization request message and checks it against a list of approved and/or disapproved MCCs based on the limitations 516 set by the primary cardholder 502. The financial account proxy system 26 declines the transaction if the transaction violates any of the limitations 516 imposed on the limited use machine-readable code 520. Alternatively, the financial account proxy system 26 authorizes or allows the transaction if the transaction data does not violate any of the limitations 516.

In some suitable embodiments, the limitations 516 may include a spending limit, a time limit, and/or a geolocation limit. If any of the limitations 516 are violated, the transaction is declined by the financial account proxy system 26. As such, the financial account proxy system 26 facilitates the primary cardholder 502 to control the types and amounts of transactions that the secondary cardholder 504 can make with the limited use machine-readable code 520.

The financial account proxy application 28 may send notifications 518 to the primary cardholder 502 regarding registering the limited use machine-readable code 520 and/or transactions made by the secondary cardholder 504, including for example, whether the transaction violated one or more of the limitations 516. The financial account proxy system 26 allows the primary cardholder 502 and secondary cardholder 504 to access the limited use machine-readable code 520 via the financial account proxy application 28 via the cardholder's digital wallet 306. Furthermore, the primary cardholder 502 and secondary cardholder 504 may view any of the limitations 516 associated with the limited use machine-readable code 520, for example, via the financial account proxy application 28.

The financial account proxy application 28 allows the primary cardholder 502 to create, read, update, and delete the limitations 516 by accessing the financial account proxy system 26 directly through the first cardholder device 22, for example, via the digital wallet 306 and/or via a web browser (not shown). The limited use machine-readable code 520 and the limitations 516 are transferred to the second cardholder device 24 of the secondary cardholder 504, for example, to the corresponding digital wallet 306, after user authentication as described above. The secondary cardholder 504 may view the limitations 516 (e.g., in the digital wallet 306) and may use the limited use machine-readable code 520 (e.g., via the digital wallet 306) to perform a financial transaction with a merchant 12, for example, via a POS device 34. For example, the secondary cardholder 504 may enter into a transaction by displaying the limited use machine-readable code 520 on a display of the second cardholder device 24 and placing the displayed limited use machine-readable code 520 near the POS device 34. In this manner, the POS device 34 may capture an image of the limited use machine-readable code 520, which may then be used to perform a transaction.

The financial account proxy application 28 allows the primary cardholder 502 to access the limited use machine-readable code 520 to update the limitations 516 (e.g., change spending limits, time limits, add or remove secondary cardholders 504, etc.) at any time after the limited use machine-readable code 520 is created. Any changes made to the limitations 516 (i.e., limitations created, updates, and/or deleted) of the limited use machine-readable code 520 are associated with and stored in the database 40. Furthermore, the changes to the limitations 516 may be propagated (i.e., transmitted) automatically to the second cardholder device 24 (e.g., the corresponding digital wallet 306) so the secondary cardholder 504 is informed of the new limitations. Furthermore, the primary cardholder 502 may delete or cancel the limited use machine-readable code 520 at any time. As such, the limited use machine-readable code 520 will automatically be removed from the second cardholder device 24. In some instances, the limited use machine-readable code 520 may be a single use machine-readable code. In such instances, the primary cardholder 502 may delete or cancel the limited use machine-readable code 520 at any time prior to its use.

In some embodiments, the primary cardholder 502 may select to manually allow a transaction by the secondary cardholder 504 with the limited use machine-readable code 520. For example, if a large purchase is anticipated, the primary cardholder 502 may choose to be notified of the transaction via a notification 518 at the time the transaction is being attempted. Upon notification of the transaction, the primary cardholder 502 may deny or allow the transaction to continue, for example, via the financial account proxy application 28 and or the first cardholder device 22, for example, via the corresponding digital wallet 306.

### Exemplary Computer-Implemented Methods

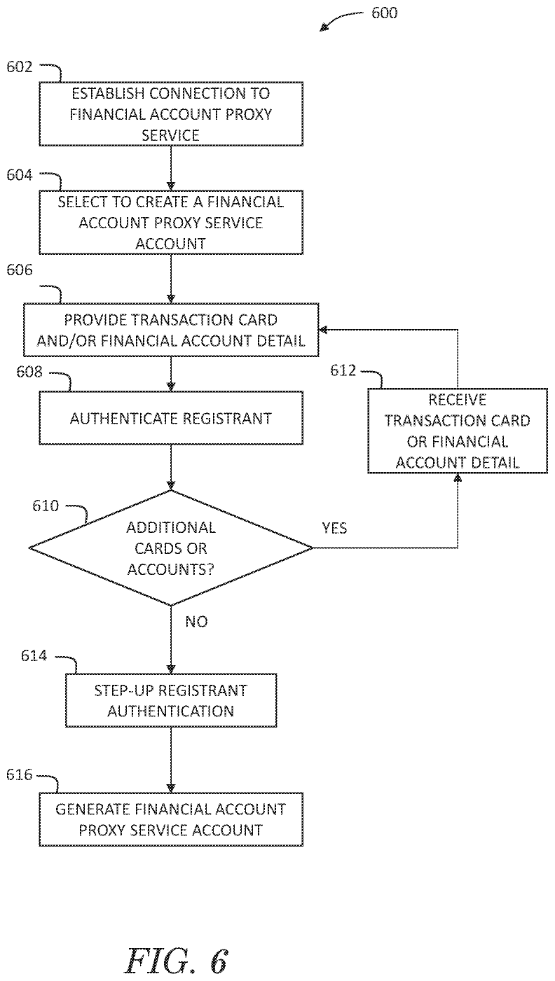

FIG. 6 is a flowchart illustrating an exemplary computer-implemented method 600 for registering one or more of the primary cardholder 502 (shown in FIG. 5) and the secondary cardholder 504 (shown in FIG. 5) (any of which are referred to below as the registrant) for the financial account proxy service provided by the financial account proxy system 26, in accordance with one embodiment of the present disclosure. The operations described herein may be performed in the order shown in FIG. 6 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 600 is described below, for ease of reference, as being executed by exemplary devices and components introduced with the embodiments illustrated in FIGS. 1-5. In one embodiment, the computer-implemented method 600 is implemented by the financial account proxy system 26 (shown in FIG. 1). In the exemplary embodiment, the computer-implemented method 600 relates to receiving registration information from one or more of the first cardholder device 22 and the second cardholder device 24 upon registration for the financial account proxy service. While operations within the computer-implemented method 600 are described below regarding the financial account proxy system 26, according to some aspects of the present invention, the computer-implemented method 600 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

The registrant must be registered for the financial account proxy service to create and/or receive a limited use machine-readable code 520 (shown in FIG. 5). Referring to operation 602, in the example embodiment, the registrant connects to the financial account proxy system 26 via the interchange network 16, e.g., via the financial account proxy application 28 (shown in FIG. 1), which is configured for direct connection to the financial account proxy system 26. Alternatively, the registrant may access the financial account proxy system 26 via a webservice providing financial account proxy service registration via use of a web browser. The financial account proxy application 28 may be stored in a cloud-based interface, which may include cloud storage capability as well as any cloud-based application programming interface (API) that facilitates communication between a registrant computing device and the financial account proxy system 26.

At operation 604, the registrant is presented an option to create a financial account proxy service account (i.e., the user account 508 (shown in FIG. 5)). For example, the registrant registers or enrolls for the financial account proxy service via a suitable webpage of the financial account proxy system 26 using, for example, a registrant computing device, such as the first cardholder device 22 or the second cardholder device 24. It should be understood that the registrant may enroll or register with the financial account proxy service in any of several ways, including utilizing a suitable computing device to access the financial account proxy system 26 via the Internet and providing the requisite information. During enrollment, the registrant may provide enrollment data including basic information about itself (e.g., name, address, phone number, etc.) and, in some embodiments, provide information regarding the registrant's computing device (for example, by providing a hardware identifier, a SIM identifier, a mobile telephone number, and/or other computing device identifier). It is noted that the financial account proxy service account can be linked to other Mastercard services if the registrant is already signed up for other unrelated services. In some embodiments, the information obtained from the registrant during the enrollment process includes product and/or service preferences, requirements data, and/or other information.

At operation 606, the registrant provides information concerning its associated financial account(s). For example, for a cardholder, such as the primary cardholder 502, the associated financial account(s) may include one or more transaction cards (e.g., a bank credit card primary account number, debit card primary account number, loyalty card primary account number, gift card primary account number, and the like) issued to or held by the primary cardholder 502.

At operation 608, the financial account proxy system 26 authenticates the registrant. For example, and without limitation, the financial account proxy system 26 may authenticate the registrant via a one-time code sent to the registrant computing device, such as the first cardholder device 22 or the second cardholder device 24, for example, via Short Message Service (SMS), e-mail, through a call center communication, and the like. Alternatively, or in addition, for the primary cardholder 502, the primary cardholder 502 may be asked to input a string of characters indicated by a code printed on the signature panel of the primary cardholder's 502 transaction card. The signature panel code may be, for example, a card verification code (CVC) value. The values entered by the primary cardholder 502 may be used by the financial account proxy system 26 to authenticate the primary cardholder 502 prior to setting up the financial account proxy service account and associating the primary cardholder 502 and the cardholder's transaction card with the account. For example, the financial account proxy system 26 compares the entered values to the values associated with the transaction card stored in a database (e.g., the database 40 shown in FIG. 1). If the entered values match the stored values, the primary cardholder 502 is authenticated. Optionally, the method 600 may include an additional operation for authenticating the registrant offline. For example, and without limitation, the financial account proxy system 26 may provide an offline PIN to the registrant via mail.

At operation 610, the financial account proxy system 26 asks the registrant whether the registrant has additional transaction cards or financial accounts it wishes to associate with the financial account proxy service account. If the registrant has additional transaction cards or financial accounts to enter, at operation 612, the financial account proxy system 26 receives the transaction card or financial account details from the registrant and returns to operation 606. If the registrant does not have any additional transaction cards or financial accounts to enter, the method continues to operation 614.

At operation 614, the financial account proxy system 26 requests that the registrant set up a step-up authentication method, i.e., two-factor authentication. For example, and without limitation, in one embodiment, the registrant is requested to establish account access credentials, e.g., to select a username and password or PIN (personal identification number) to be used for security purposes, and/or for use by the registrant to login and change one or more preferences related to the financial account proxy service. In addition to the password or PIN, the registrant may be requested to set up a second authentication factor that is to be associated with the other registration information provided.

In one suitable embodiment, the second factor may include, for example, and without limitation, SMS two-factor authentication (where a one-time use short code is sent to the registrant computing device, such as the first cardholder device 22 or the second cardholder device 24, via SMS), Time-Based One Time Password (TOTP) authentication (where an authenticator application provides a short code as a second factor), push-based two-factor authentication (where a prompt is pushed out to the registrant computing device, such as the first cardholder device 22 or the second cardholder device 24), or any other two-factor authentication method that enables the method 600 to operate as described herein.

In another suitable embodiment, the second factor may include a biometric sample. Biometric samples include, without limitation, a fingerprint image, a voice recording, a retinal image, facial recognition, palm print image, iris recognition, and the like. The biometric sample is unique to the registrant (e.g., the cardholders 502 or 504) and difficult to duplicate and/or forge by an unauthorized user. The biometric sample may be stored and associated with a biometric identifier, for example, by the financial account proxy system 26 (e.g., in the biometrics module 512, the database 40, etc.). Additionally, the biometric identifier is associated with the stored registration information and facilitates secure authorization of requested data input by the registrant. A biometric input device in communication with the registrant computing device, such as the first cardholder device 22 or the second cardholder device 24, may be used for the registrant to enter the biometric sample. For example, the registrant computing device may include an integral fingerprint or palm reader/scanner, retinal or iris reader/scanner, and/or voice reader/recorder.

At operation 616, the financial account proxy system 26 generates the financial account proxy service account (i.e., the user account 508) for the registrant, associating the received one or more transaction cards and/or financial accounts with the account along with the registrant's account access credentials, and stores the financial account proxy service account in a database, such as the database 40.

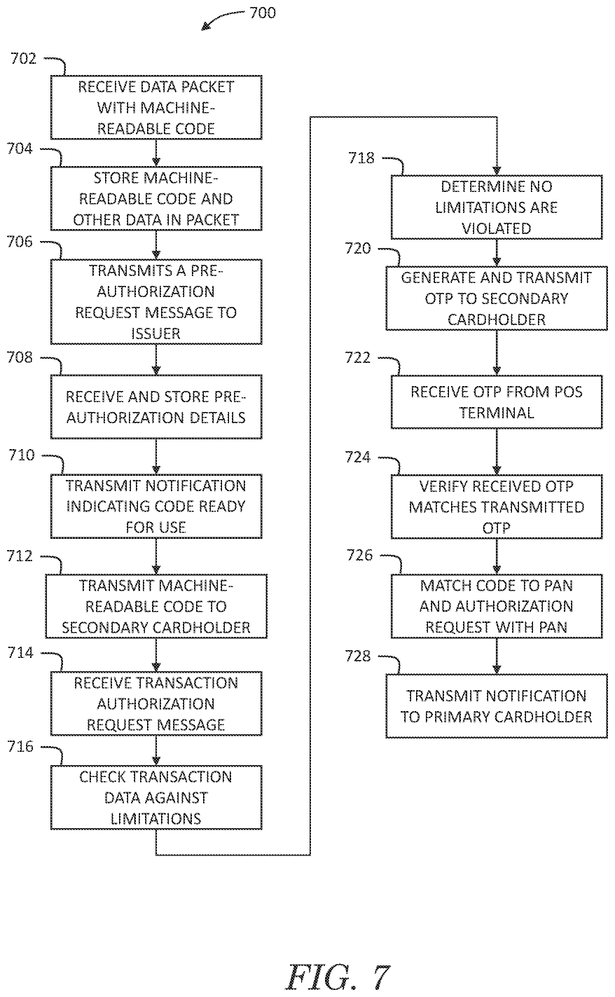

FIG. 7 is a flow chart of an example method 700 for creating and sharing a limited use machine-readable code associated with a primary cardholder's financial account (or PAN) with a secondary cardholder, in accordance with one embodiment of the present disclosure. The operations described herein may be performed in the order shown in FIG. 7 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 700 is described below, for ease of reference, as being executed by exemplary devices and components introduced with the embodiments illustrated in FIGS. 1-5. In the example embodiment, the method 700 is implemented by the financial account proxy system 26 (shown in FIG. 1). The method 700 is a computer-implemented method for receiving requests from the primary cardholder 502 (shown in FIG. 5) to create and share the limited use machine-readable code 520 with the secondary cardholder 504 (shown in FIG. 5). While operations within the computer-implemented method 700 are described below regarding the financial account proxy system 26, according to some aspects of the present invention, the computer-implemented method 700 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

At operation 702, the financial account proxy system 26 receives a request from a user, such as the primary cardholder 502, to create a limited use machine-readable code 520 (shown in FIG. 5) in the financial account proxy system 26. More particularly, the financial account proxy system 26 receives, for example, via an application programming interface (API) call, a data packet from the digital wallet 306 of the first cardholder device 22. The data packet includes, for example, a limited use machine-readable code 520, receiver information, one or more limitations 516 (shown in FIG. 5), and/or sender information (e.g., the identification data 506 associated with the primary cardholder 502). For example, the primary cardholder 502 may open his or her digital wallet 306 and select to generate the limited use machine-readable code 520 associated with his or her financial account or PAN. The primary cardholder 502 selects a receiver of the limited use machine-readable code 520, such as the secondary cardholder 504. The secondary cardholder 504 may be selected, for example, from a list of contacts stored on the first cardholder device 22 or from a list of registered users of the financial account proxy system 26. In some embodiments, the digital wallet 306 receives, via an API call, a list of registered users of the financial account proxy system 26. In some embodiments, the primary cardholder 502 may input receiver information directly into the digital wallet. The receiver information may include, for example, contact information of the receiver, such as a phone number, email address, and the like. Furthermore, the primary cardholder 502 may select and/or input the one or more limitations 516 to be associated with the limited use machine-readable code 520. The limitations 516 may include, for example, one or more of a time restriction or limit, a spending amount, a transaction number limit, a geolocation or geofence, a Merchant Category Code(s) (MCCs), a merchant name(s), and/or other merchant identifiers.

At operation 704, the financial account proxy system 26 stores the limited use machine-readable code 520, the receiver information, the one or more limitations 516 that are established by the primary cardholder 502, and the sender information, for example, in database 40. The limited use machine-readable code 520 is associated with the financial account or PAN of the primary cardholder 502, which was established as part of the primary cardholder's 502 account, as described herein with respect to method 600.

At operation 706, the financial account proxy system 26 transmits a pre-authorization request message to the issuer of the financial account associated with the machine-readable code 520, such as the issuer 18 (shown in FIG. 1), using the associated financial account or PAN. In the example embodiment, the pre-authorization request message places a temporary hold on the spending amount included in the limitations 516 that last for the time restriction or limit included in the limitations 516. If the limitations do not include a time restriction or limit, the temporary hold may last for a predetermined period, such as one (1) day, three (3) days, or any other pre-determined period. During the temporary hold, the primary cardholder 502 cannot spend the amount on hold, but the hold may not actually show up on their credit card statement. Within the period of the temporary hold, the machine-readable code 520 must be used. After the period of the temporary hold expires, the funds are released by the issuer 18 back to the primary cardholder 502. Because pre-authorizations are not settlements and are not shown as charges on the primary cardholder's 502 account, the primary cardholder 502 cannot dispute the transaction or issue a chargeback (e.g., receive a refund).

At operation 708, the financial account proxy system 26 receives and stores pre-authorization details from the issuer 18 in the database 40 along with the associated limited use machine-readable code 520.

At operation 710, the financial account proxy system 26 transmits an alert, such as the notifications 518 (shown in FIG. 5), to the primary cardholder 502 via the first cardholder device 22 (such as through the digital wallet 306) after the limited use machine-readable code 520 and associated data has been stored in the database 40, and after pre-authorization, such that the limited use machine-readable code 520 is ready for use.

At operation 712, the financial account proxy system 26 transmits the limited use machine-readable code 520 to the secondary cardholder's digital wallet 306 stored on the second cardholder device 24. At an operation 714, the financial account proxy system 26 receives a transaction authorization request message that includes the limited use machine-readable code 520. The financial account proxy system 26 checks transaction data or information contained in the transaction authorization request message against the limitations 516 established for the limited use machine-readable code 520 at operation 716. The financial account proxy system 26 declines the transaction if it is determined that the transaction violates a limitation 516 imposed on the limited use machine-readable code 520.

At operation 718, the financial account proxy system 26 determines that the transaction does not violate a limitation 516. Upon such a determination, at operation 720, the financial account proxy system 26 generates a one-time password (OTP) and transmits the OTP to the second cardholder device 24, for example, via the digital wallet 306. The secondary cardholder 504 inputs the OTP, for example, into the POS terminal 34, to continue the transaction. At operation 722, the financial account proxy system 26 receives the OTP inputted by the secondary cardholder 504 from the merchant POS terminal 34, for example, via the acquirer 14. Upon receipt of the inputted OTP, the financial account proxy system 26 verifies that the received (i.e., inputted) OTP matches the generated OTP, at operation 724.

Upon a successful match, at operation 726, the financial account proxy system 26 matches the limited use machine-readable code 520 to the PAN and transmits a transaction authorization request message that includes the PAN to the issuer 18, for example, via the interchange network 16 for processing the transaction business as usual. In the example embodiment, the pre-authorization request message and the transaction authorization request message can be ISO 8583 messages. In certain embodiments of the present invention, the interchange network 16 transmits a transaction status message to the POS terminal 34, indicating, for example, whether the transaction was authorized or denied.

At operation 728, the financial account proxy application 28 transmits a notification 518 to the primary cardholder 502 including details of transactions made by the secondary cardholder 504, including for example, whether the transaction violated one or more limitations 516. In one embodiment, the notifications may include an authorization request. In such an embodiment, the primary cardholder 502 may choose to manually allow a transaction being made by the secondary cardholder 504. As such, the financial account proxy system 26 receives authorization for the transaction from the primary cardholder 502 and allows the transaction to continue. It is noted that the limited use machine-readable code 520 may be usable in more than one transaction. For example, the limitations 516 may include an amount and a time limitation. In such an example, the limited use machine-readable code 520 may be used in any number of transactions before the time limitation has passed and until the amount is spent. After the transaction(s) has been processed, declined, and/or the time limitations has been met or exceeded, a number of transactions has been met, and/or an amount limitation has been met, the financial account proxy system 26 voids the limited use machine-readable code 520.

Any actions, functions, operations, and the like recited herein may be performed in the order shown in the figures and/or described above or may be performed in a different order. Furthermore, some operations may be performed concurrently as opposed to sequentially. Although the computer-implemented method is described above, for the purpose of illustration, as being executed by an example system and/or example physical elements, it will be understood that the performance of any one or more of such actions may be differently distributed without departing from the spirit of the present disclosure.

### ADDITIONAL CONSIDERATIONS

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transaction card can be used as a method of payment for performing a transaction.

As used herein, the term “cardholder” may refer to the owner or rightful possessor of a payment card. As used herein, the term “cardholder account” may refer specifically to a PAN or more generally to an account a cardholder has with the payment card issuer and that the PAN is or was associated with. As used herein, the term “merchant” may refer to a business, a charity, or any other entity that can generate transactions with a cardholder account through a payment card network.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor includes a general-purpose processor configured using software, the general-purpose processor may be configured as respective different processors at separate times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at separate times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a specific location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

1. A financial account proxy system comprising:
a processor; and
a memory device storing computer-executable instructions thereon, that when executed by the processor, cause the processor to:
receive, via an API call, a data packet from a first cardholder device associated with a primary cardholder, the data packet including a limited use machine-readable code, receiver information corresponding to a second cardholder device associated with a secondary cardholder, and one or more limitations;
store the limited use machine-readable code, receiver information, and one or more limitations in the memory device, wherein the limited use machine-readable code is stored in association with a primary account number (PAN) of a financial account of the primary cardholder;
transmit a pre-authorization request message to an issuer of the financial account of the primary cardholder;
receive pre-authorization details from the issuer and store the pre-authorization details in the memory device;
transmit the limited use machine-readable code to the second cardholder device based on the receiver information;
receive a transaction request authorization message from a merchant point-of-sale (POS) terminal, the transaction request authorization message associated with a transaction performed with the limited use machine-readable code, the transaction request authorization message including transaction details and the limited use machine-readable code; and
determine whether the transaction details violate one of the one or more limitations.

2. The financial account proxy system in accordance with claim 1,
said computer-executable instructions causing the processor to generate a one-time password (OTP) and transmit the generated OTP to the second cardholder device based on a determination that the transaction details do not violate one of the one or more limitations.

3. The financial account proxy system in accordance with claim 2,
said computer-executable instructions causing the processor to receive a second OTP from the merchant POS terminal and match the second OTP to the generated OTP.

4. The financial account proxy system in accordance with claim 3,
said computer-executable instructions causing the processor to:
match the limited use machine-readable code to the PAN; and
transmit a transaction authorization request message that includes the PAN to the issuer.

5. The financial account proxy system in accordance with claim 1,
said one or more limitations includes one or more of the following: a time restriction or limit, a spending amount, and a transaction number limit,
said computer-executable instructions causing the processor to void the limited use machine-readable code after one or more of the following: the transaction has been processed, the transaction has been declined, the time restriction or limit has been met or exceeded, the spending amount has been met, and the transaction number limit has been met.

6. The financial account proxy system in accordance with claim 1,
said computer-executable instructions causing the processor to transmit a notification to the primary cardholder, the notification including details of the transaction.

7. The financial account proxy system in accordance with claim 6,
said notification including whether the transaction violated one of the one or more limitations.

8. The financial account proxy system in accordance with claim 1,
said computer-executable instructions causing the processor to decline the transaction based on a determination that the transaction details violate one of the one or more limitations.

9. The financial account proxy system in accordance with claim 1,
said computer-executable instructions causing the processor to:
match the limited use machine-readable code to the PAN based on a determination that the transaction details do not violate one of the one or more limitations; and
transmit a transaction authorization request message that includes the PAN to the issuer.

10. The financial account proxy system in accordance with claim 1,
said one or more limitations includes one or more of the following: a time restriction or limit, a spending amount, a transaction number limit, a geolocation or geofence, a Merchant Category Code(s), and a merchant name(s).

11. A computer-implemented method comprising:
receiving, via an API call, a data packet from a first cardholder device associated with a primary cardholder, the data packet including a limited use machine-readable code, receiver information corresponding to a second cardholder device associated with a secondary cardholder, and one or more limitations;
storing the limited use machine-readable code, receiver information, and one or more limitations in a memory device, wherein the limited use machine-readable code is stored in association with a primary account number (PAN) of a financial account of the primary cardholder;
transmitting a pre-authorization request message to an issuer of the financial account of the primary cardholder;
receiving pre-authorization details from the issuer and storing the pre-authorization details in the memory device;
transmitting the limited use machine-readable code to the second cardholder device based on the receiver information;
receiving a transaction request authorization message from a merchant point-of-sale (POS) terminal, the transaction request authorization message associated with a transaction performed with the limited use machine-readable code, the transaction request authorization message including transaction details and the limited use machine-readable code; and
determining whether the transaction details violate one of the one or more limitations.

12. The computer-implemented method in accordance with claim 11, further comprising generating a one-time password (OTP) and transmitting the generated OTP to the second cardholder device based on a determination that the transaction details do not violate one of the one or more limitations.

13. The computer-implemented method in accordance with claim 12, further comprising receiving a second OTP from the merchant POS terminal and matching the second OTP to the generated OTP.

14. The computer-implemented method in accordance with claim 13, further comprising:
matching the limited use machine-readable code to the PAN; and
transmitting a transaction authorization request message that includes the PAN to the issuer.

15. The computer-implemented method in accordance with claim 11, wherein the one or more limitations includes one or more of the following: a time restriction or limit, a spending amount, and a transaction number limit,
said method further comprising voiding the limited use machine-readable code after one or more of the following: the transaction has been processed, the transaction has been declined, the time restriction or limit has been met or exceeded, the spending amount has been met, and the transaction number limit has been met.

16. The computer-implemented method in accordance with claim 11, further comprising transmitting a notification to the primary cardholder, the notification including details of the transaction.

17. The computer-implemented method in accordance with claim 16, wherein the notification includes whether the transaction violated one of the one or more limitations.

18. The computer-implemented method in accordance with claim 11, further comprising declining the transaction based on a determination that the transaction details violate one of the one or more limitations.

19. The computer-implemented method in accordance with claim 11, further comprising:
matching the limited use machine-readable code to the PAN based on a determination that the transaction details do not violate one of the one or more limitations; and
transmitting a transaction authorization request message that includes the PAN to the issuer.

20. The computer-implemented method in accordance with claim 11, wherein the one or more limitations includes one or more of the following: a time restriction or limit, a spending amount, a transaction number limit, a geolocation or geofence, a Merchant Category Code(s), and a merchant name(s).
